(19) United States
(12) Patent Application Publication
(10) Pub. No.: US 2014/0089136 A1
(43) Pub. Date: Mar. 27, 2014

(54) USING FINANCIAL TRANSACTIONS TO GENERATE RECOMMENDATIONS

(71) Applicant: INTUIT INC., Mountain View, CA (US)

(72) Inventors: Saikat Mukherjee, Fremont, CA (US); Sony Joseph, Mountain View, CA (US)

(21) Appl. No.: 13/685,506

(22) Filed: Nov. 26, 2012

Related U.S. Application Data
(60) Provisional application No. 61/706,672, filed on Sep. 27, 2012.

(51) Int. Cl. G06Q 30/06

(52) U.S. Cl. CPC G06Q 30/0631
USPC 705/26.7

(57) ABSTRACT

The disclosed embodiments provide a system that processes transaction data. During operation, the system obtains the transaction data for a set of financial transactions between a set of users and a set of organizations. Next, the system uses the transaction data to calculate a set of preference scores for the users and the organizations. Finally, the system generates recommendations associated with the users and the organizations from the preference scores without obtaining explicit preferences for the organizations from the users.

### BACKGROUND

### Related Art

The disclosed embodiments relate to recommendation systems. More specifically, the disclosed embodiments relate to techniques for making recommendations using transaction data for financial transactions between a set of users and a set of organizations.

### SUMMARY

The disclosed embodiments provide a system that processes transaction data. During operation, the system obtains the transaction data for a set of financial transactions between a set of users and a set of organizations. Next, the system uses the transaction data to calculate a set of preference scores for the users and the organizations. Finally, the system generates recommendations associated with the users and the organizations from the preference scores without obtaining explicit preferences for the organizations from the users.

In some embodiments, the system also updates the transaction data with new financial transactions between the users and the organizations, and updates the preference scores based on the updated transaction data.

In some embodiments, using the transaction data to calculate the set of preference scores for the users and the organizations involves calculating a preference score for each user from the set of users and each organization from the set of organizations.

In some embodiments, the preference score includes at least one of an inverse document frequency score, a spending score, and a visit score.

In some embodiments, the spending score is at least one of a first spending score for the user normalized across the set of users and a second spending score for the user normalized across the set of organizations.

In some embodiments, the visit score is at least one of a first visit score for the user normalized across the set of users and a second visit score for the user normalized across the set of organizations.

In some embodiments, using the preference scores to generate recommendations associated with the users and the organizations involves at least one of recommending the organizations to the users based on correlations among the preference scores for the users and enabling cross-promotion among the organizations based on the correlations.

In some embodiments, the transaction data for each financial transaction from the set of financial transactions includes at least one of an organization, a transaction date, and a transaction amount.

### BRIEF DESCRIPTION OF THE FIGURES

FIG. 1 shows a schematic of a system in accordance with the disclosed embodiments.

FIG. 2 shows the calculation of a preference score in accordance with the disclosed embodiments.

FIG. 3 shows a flowchart illustrating the process of processing transaction data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for processing transaction data. The data may correspond to transaction data for financial transactions between a set of users and a set of organizations. For example, the transaction data may describe completed transactions and/or upcoming financial transactions between the user and a bank, credit card company, merchant, lender, seller, brokerage, and/or other organization. In addition, the transaction data may specify the organization, transaction date, and/or transaction amount for the corresponding transaction. For example, transaction data for a transaction between a user and an electronic commerce company may include the time and date of the transaction, the name of the electronic commerce company, and the amount spent by the user at the electronic commerce company.

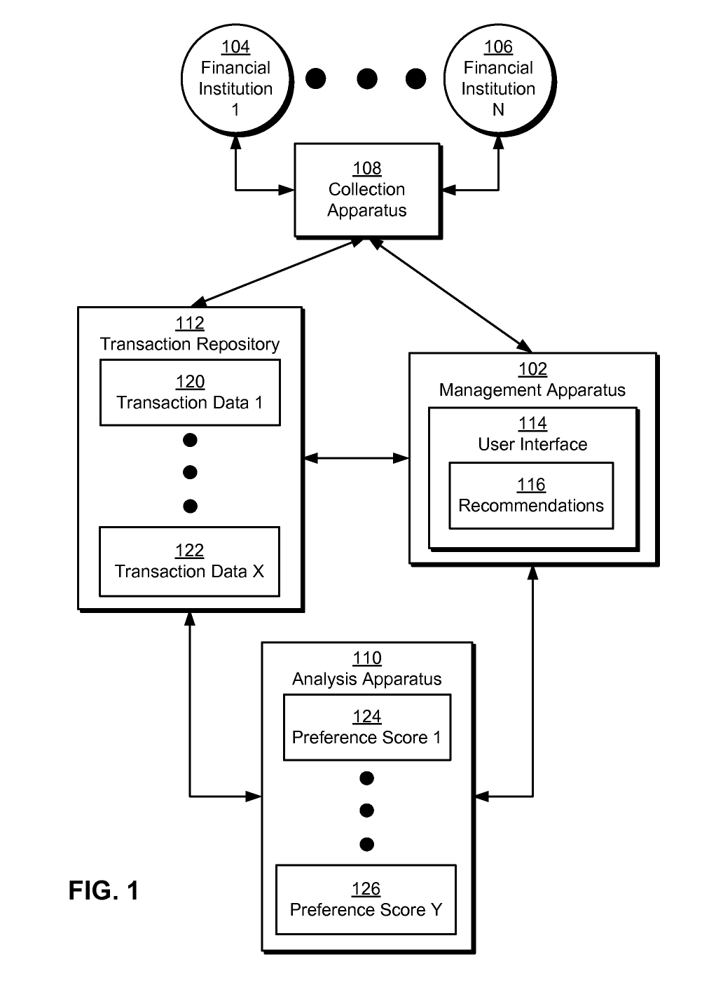

As shown in FIG. 1, a collection apparatus 108 may obtain the transaction data (e.g., transaction data 1 120, transaction data x 122) from a set of financial institutions (e.g., financial institution 1 104, financial institution n 106) and store the transaction data in a transaction repository 112. For example, collection apparatus 108 may be used by a financial-management application to aggregate transaction data for financial transactions between users of the financial-management application and a set of organizations (e.g., businesses, companies, etc.). Alternatively, some or all of the transaction data may be obtained from the organizations, the users, and/or other entities associated with the financial transactions.

The system of FIG. 1 may then use the aggregated transaction data to perform one or more tasks for the users. For example, a management apparatus 102 may provide a user interface 114 (e.g., graphical user interface (GUI), web-based user interface, etc.) that allows the users to track budgets, spending habits, account balances, bill payments, and/or other metrics and/or activity associated with the users' finances and/or financial transactions.

To increase use of the transaction data and/or user interface 114, the system of FIG. 1 may provide a recommendation system that generates recommendations 116 associated with the users and/or organizations from the transaction data. Furthermore, such recommendations may be provided without obtaining explicit preferences from the users.

More specifically, an analysis apparatus 110 may use the transaction data to calculate a set of preference scores (e.g., preference score 1 124, preference score y 126) for the users and organizations. Higher preference scores may represent higher preferences for the organizations by the users, while lower preference scores may represent lower preferences for the organizations by the users. In other words, the preference scores may represent the users' implicit preferences for the organizations as determined from the users' financial transaction activity with the organizations.

In addition, a different preference score may be calculated for each combination of user and organization. For example, analysis apparatus 110 may keep the preference scores in a matrix containing rows that represent users and columns that represent organizations. Each element in the matrix may thus represent the preference score for the user specified by the element's row given the organization specified by the element's column.

To facilitate assessment of the users' preferences from the transaction data, each preference score may be calculated from a number of components, including an inverse document frequency (IDF) score, a spending score, and/or a visit score. The IDF score may be a general measure of the overall “popularity” of an organization. For example, the IDF score for the organization may be lower if a higher proportion of users have conducted financial transactions (e.g., made purchases) with the organization and higher if a lower proportion of users have conducted financial transactions with the organization. In other words, the IDF score may be inversely related to the proportion of users that have transacted with the organization.

The spending score may compare the spending habits of an individual user with those of other users at the same organization and/or the same user at different organizations. For example, the spending score may be higher if the user spends more than the average spent by all users at the organization and/or the average spent by the user across all organizations. On the other hand, the spending score may be lower if the user spends less than the average spent by all users at the same organization and/or the average spent by the user across all organizations.

Along the same lines, the visit score may compare the frequency with which the user visits (e.g., spends money at) an organization with those of other users at the same organization and/or the same user at different organizations. For example, the visit score may be higher if the user frequently visits (e.g., performs financial transactions with) the organization compared to other users on average and/or the user's average number of visits to all organizations. Conversely, the visit score may be lower if the user rarely visits the organization compared to other users on average and/or the user's average number of visits to all organizations.

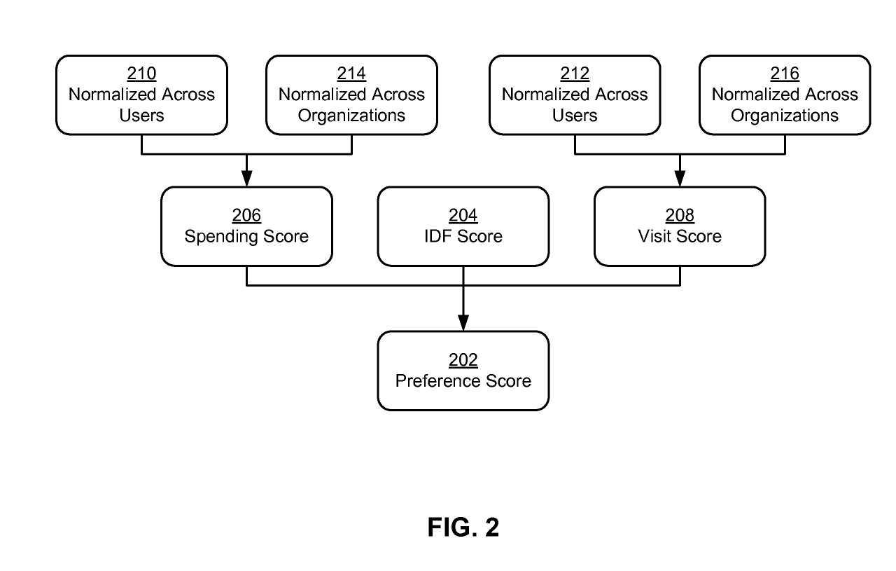

The IDF score, spending score, and/or visit score may then be combined to obtain the preference score for a given user and organization. For example, the IDF, spending, and visit scores may be multiplied to obtain the preference score. If the user has not performed any financial transactions with the organization, the IDF score for the organization may be used as a “default” preference score for the user and organization. Calculation of preference scores is discussed in further detail below with respect to FIG. 2.

After the preference scores are calculated by analysis apparatus 110, the preference scores may be used by management apparatus 102 to generate recommendations 116 associated with the users and organizations. In particular, management apparatus 102 may recommend the organizations to the users based on correlations among the preference scores for the users. For example, management apparatus 102 may use an item-to-item collaborative filtering technique to predict a user's preference for a particular organization based on the preference scores of similar users. The predicted preference may additionally be weighted by the IDF score for the organization, such that predicted preferences for popular and/or well-known organizations are less strong than predicted preferences for more obscure and/or less popular organizations. Management apparatus 102 may then make recommendations 116 of one or more organizations to the user within user interface 114 if the predicted preferences for the organization(s) are high. In other words, management apparatus 102 may recommend an organization to the user if the user is not well acquainted with the organization and/or is likely to prefer the organization based on the user's implicit preferences for other organizations.

Management apparatus 102 may additionally enable cross-promotion among the organizations based on the correlations. For example, management apparatus 102 may allow two organizations with strongly correlated preference scores to attract more customers by displaying special deals and/or offers within user interface 114, one another's websites, and/or one another's storefronts.

The system of FIG. 1 may additionally update the preference scores and recommendations 116 based on updates to the transaction data. For example, collection apparatus 108 may periodically and/or continually update the transaction data in transaction repository 112 with new financial transactions between the users and organizations. Analysis apparatus 110 may then recalculate the preference scores based on the updated transaction data, and management apparatus 102 may modify recommendations 116 based on the recalculated preference scores. For example, collection apparatus 108, analysis apparatus 110, and/or management apparatus 102 may update the preference scores and/or recommendations 116 to reflect changes in the users' spending habits and/or living situations over time.

As a result, the system of FIG. 1 may maintain an up-to-date representation of users' implicit preferences for a variety of organizations without requiring the users to provide explicit ratings, reviews, and/or opinions of the organizations. In turn, the generation of recommendations 116 based on the implicit preferences may increase the value and/exposure of the users and organizations to each other without increasing the overhead associated with using user interface 114 and/or other components of the recommendation system.

FIG. 2 shows the calculation of a preference score 202 in accordance with the disclosed embodiments. Preference score 202 may be calculated from a number of components and/or other scores, including an IDF score 204, a spending score 206, and a visit score 208. Spending score 206 and visit score 208 may additionally be separated into components that are normalized across users 210-212 and normalized across organizations 214-216.

As mentioned above, preference score 202 may be calculated by combining IDF score 204, spending score 206, and/or visit score 208. For example, preference score 202 may be calculated by multiplying IDF score 204, spending score 206, and visit score 208. In addition, spending score 206 may be calculated by multiplying a first spending score normalized across a set of users 210 and a second spending score normalized across a set of organizations 214. Similarly, visit score 208 may be calculated by multiplying a first visit score normalized across the set of users 212 with a second visit score normalized across the set of organizations 216.

For example, preference score 202 may be calculated using the following functions:

Pref(u,r)=IDF(r)*Spend(u,r)*Visit(u,r)

IDF(r)=1+log(N/N(r))

Spend(u,r)=NormalizedAcrossUsersSpend(u,r)*NormalizedAcrossOrgsSpend(u,r)

NormalizedAcrossUsersSpend(u,r)=log(1+M(u,r)/Mavg(r))

NormalizedAcrossOrgsSpend(u,r)=1+M(u,r)/M(u)

Visit(u,r)=NormalizedAcrossUsersVisit(u,r)*NormalizedAcrossOrgsVisit(u,r)

NormalizedAcrossUsersVisit(u,r)=log(1+N(u,r)/Navg(r))

NormalizedAcrossOrgsVisit(u,r)=1+N(u,r)/N(u)

Within the functions, a user u and an organization r are provided as inputs to a function Pref for preference score 202. In addition, preference score 202 may be calculated by multiplying an IDE function representing IDF score 204, a Spend function representing spending score 206, and a Visit function representing visit score 208. Within the IDE function, N(r) may represent the number of users who have visited r at least once, and N may represent the total number of users used in the calculation of preference score 202.

Spending score 206 may be calculated by multiplying a NormalizedAcrossUsersSpend function representing the first spending score normalized across users 210 with a NormalizedAcrossOrgsSpend function representing the second spending score normalized across organizations 214. M(u,r) may specify the average amount spent by u at r over a pre-specified period (e.g., one month, one year, etc.), Mavg(r) may specify the average amount spent by all users at r over the same period, and M(u) may represent the average amount spent by u across all organizations over the same period.

Similarly, visit score 208 may be calculated by multiplying a NormalizedAcrossUsersVisit function representing the first visit score normalized across users 212 with a NormalizedAcrossOrgsVisit function representing the second visit score normalized across organizations 216. N(u,r) may indicate the number of visits by u to r over the pre-specified period, Navg(r) may indicate the average number of visits to r by all users over the pre-specified period, and N(u) may indicate the average number of visits by u to all organizations.

The functions may then be used with the following table of transaction data, which includes purchases by five users u1-u5 at four organizations r1-r4:

| | r1 | r2 | r3 | r4 |
|---|---|---|---|---|
| u1 | $2 | | $90 | |
| u2 | $5 | | $8 | |
| u3 | $20 | | $100 | |
| u4 | $5 | | $120 | |
| u5 | $9 | | | $20 |

The transaction data may then be used to obtain the following values:

Spend(u3,r3)=(1+log(100/103))*(1+100/60)=2.59

Spend(u3,r1)=(1+log(20/720))*(1+20/60)=2.69

IDF(r1)=+log(5/5)=1.0

IDF(r2)=+log(5/1)=2.6

First, two spending scores for u3 may be calculated given r1 and r3; while u3 has spent five times more at r3 than at r1, the spending score for r1 is higher than for r3 because u3 has spent more at r1 relative to other users. Next, two IDF scores may be calculated for r1 and r2; r1, which is visited by all five users, has a much lower score than r2, which has not been visited by any users. In turn, the IDF scores may cause r2 to be recommended more than r1 to the users because r1 is likely to be already known by the users.

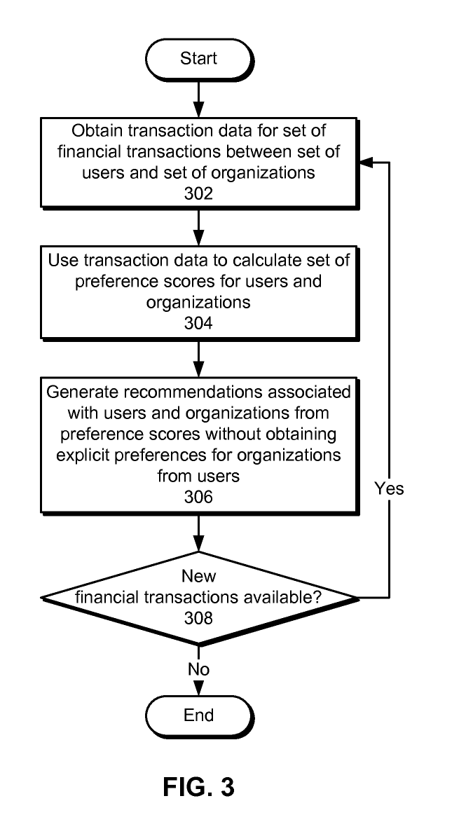

FIG. 3 shows a flowchart illustrating the process of processing transaction data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

Initially, transaction data for a set of financial transactions between a set of users and a set of organizations is obtained (operation 302). For example, the transaction data may be aggregated from a set of financial institutions, the users, and/or the organizations. In addition, the transaction data for a financial transaction may include a transaction date, a transaction amount, and/or the organization with which the financial transaction data was conducted.

Next, the transaction data is used to calculate a set of preference scores for the users and the organizations (operation 304). Each preference score may represent a user's implicit preference for an organization based on the financial transactions of the user and/or other users with the organization and/or other organizations. For example, a higher preference score may indicate a stronger preference for the organization by the user, and a lower preference score may indicate a weaker preference for the organization by the user. In addition, the preference score may be negatively influenced by the “popularity” of the organization and positively influenced by higher amounts spent and/or more frequent visits by the user relative to other users at the same organization and/or the same user at other organizations.

Recommendations associated with the users and organizations are then generated from the preference scores without obtaining explicit preferences for the organizations from the users (operation 306). For example, an item-to-item collaborative filtering technique may be used to recommend the organizations to the users based on correlations among the preference scores for the users. The correlations may also be used to enable cross-promotion among the organizations.

New financial transactions between the users and organizations may be available (operation 308). If new financial transactions are available, the transaction data is updated with the new financial transactions (operation 302), the preference scores are recalculated based on the updated transaction data (operation 304), and the recommendations are generated using the updated preference scores (operation 306). The new financial transactions may thus allow the users' preferences for the organizations to be tracked over time. If no new financial transactions are available, the transaction data, preference scores, and/or recommendations are not updated.

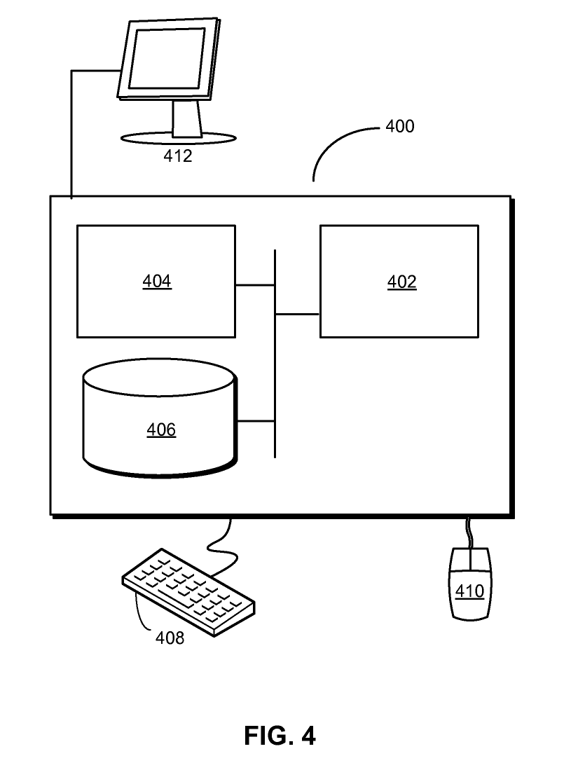

FIG. 4 shows a computer system 400. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing transaction data. The system may include a collection apparatus that obtains the transaction data for a set of financial transactions between a set of users and a set of organizations. The system may also include an analysis apparatus that uses the transaction data to calculate a set of preference scores for the users and the organizations. Finally, the system may include a recommendation apparatus that generates recommendations associated with the users and the organizations from the preference scores without obtaining explicit preferences for the organizations from the users. The collection apparatus may also periodically and/or continually update the transaction data with new financial transactions between the users and the organizations, and the analysis apparatus may update the preference scores based on the updated transaction data.

In addition, one or more components of computer system 400 may be remotely located and connected to the other components over a network. Portions of the present embodiments (e.g., collection apparatus, analysis apparatus, management apparatus, etc.) may also be located on different nodes of a distributed system that implements the embodiments. For example, the present embodiments may be implemented using a cloud computing system that provides recommendations to users of a financial-management application executing within the cloud computing system.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1. A computer-implemented method for processing transaction data, comprising:
obtaining the transaction data for a set of financial transactions between a set of users and a set of organizations;
using the transaction data to calculate a set of preference scores for the users and the organizations; and
generating recommendations associated with the users and the organizations from the preference scores without obtaining explicit preferences for the organizations from the users.

2. The computer-implemented method of claim 1, further comprising:
updating the transaction data with new financial transactions between the users and the organizations; and
updating the preference scores based on the updated transaction data.

3. The computer-implemented method of claim 1, wherein using the transaction data to calculate the set of preference scores for the users and the organizations involves:
calculating a preference score for each user from the set of users and each organization from the set of organizations.

4. The computer-implemented method of claim 3, wherein the preference score comprises at least one of:
an inverse document frequency score;
a spending score; and
a visit score.

5. The computer-implemented method of claim 4, wherein the spending score is at least one of:
a first spending score for the user normalized across the set of users; and
a second spending score for the user normalized across the set of organizations.

6. The computer-implemented method of claim 4, wherein the visit score is at least one of:
a first visit score for the user normalized across the set of users; and
a second visit score for the user normalized across the set of organizations.

7. The computer-implemented method of claim 1, wherein using the preference scores to generate recommendations associated with the users and the organizations involves at least one of:
recommending the organizations to the users based on correlations among the preference scores for the users; and
enabling cross-promotion among the organizations based on the correlations.

8. The computer-implemented method of claim 1, wherein the transaction data for each financial transaction from the set of financial transactions comprises at least one of:
an organization;
a transaction date; and
a transaction amount.

9. A system for processing transaction data, comprising:
a collection apparatus configured to obtain the transaction data for a set of financial transactions between a set of users and a set of organizations;
an analysis apparatus configured to use the transaction data to calculate a set of preference scores for the users and the organizations; and
a recommendation apparatus configured to generate recommendations associated with the users and the organizations from the preference scores without obtaining explicit preferences for the organizations from the users.

10. The system of claim 9,
wherein the collection apparatus is further configured to update the transaction data with new financial transactions between the users and the organizations, and
wherein the analysis apparatus is further configured to update the preference scores based on the updated transaction data.

11. The system of claim 9, wherein using the transaction data to calculate the set of preference scores for the users and the organizations involves:
calculating a preference score for each user from the set of users and each organization from the set of organizations.

12. The system of claim 11, wherein the preference score comprises at least one of:
an inverse document frequency score;
a spending score; and
a visit score.

13. The system of claim 12, wherein the spending score is at least one of:
a first spending score for the user normalized across the set of users; and
a second spending score for the user normalized across the set of organizations.

14. The system of claim 12, wherein the visit score is at least one of:
a first visit score for the user normalized across the set of users; and
a second visit score for the user normalized across the set of organizations.

15. The system of claim 9, wherein using the preference scores to generate recommendations associated with the users and the organizations involves at least one of:
recommending the organizations to the users based on correlations among the preference scores for the users; and
enabling cross-promotion among the organizations based on the correlations.

16. The system of claim 9, wherein the transaction data for each financial transaction from the set of financial transactions comprises at least one of:
an organization;
a transaction date; and
a transaction amount.

17. A computer-readable storage medium storing instructions that when executed by a computer cause the computer to perform a method for processing transaction data, the method comprising:
obtaining the transaction data for a set of financial transactions between a set of users and a set of organizations;
using the transaction data to calculate a set of preference scores for the users and the organizations; and
generating recommendations associated with the users and the organizations from the preference scores without obtaining explicit preferences for the organizations from the users.

18. The computer-readable storage medium of claim 17, the method further comprising:
updating the transaction data with new financial transactions between the users and the organizations; and
updating the preference scores based on the updated transaction data.

19. The computer-readable storage medium of claim 17, wherein using the transaction data to calculate the set of preference scores for the users and the organizations involves:
calculating a preference score for each user from the set of users and each organization from the set of organizations.

20. The computer-readable storage medium of claim 19, wherein the preference score comprises at least one of:
an inverse document frequency score;
a spending score; and
a visit score.

21. The computer-readable storage medium of claim 20, wherein the spending score is at least one of:
a first spending score for the user normalized across the set of users; and
a second spending score for the user normalized across the set of organizations.

22. The computer-readable storage medium of claim 20, wherein the visit score is at least one of:
a first visit score for the user normalized across the set of users; and
a second visit score for the user normalized across the set of organizations.

23. The computer-readable storage medium of claim 17, wherein using the preference scores to generate recommendations associated with the users and the organizations involves at least one of:
recommending the organizations to the users based on correlations among the preference scores for the users; and
enabling cross-promotion among the organizations based on the correlations.

24. The computer-readable storage medium of claim 17, wherein the transaction data for each financial transaction from the set of financial transactions comprises at least one of:
an organization;
a transaction date; and
a transaction amount.
